(19) United States
(12) Patent Application Publication
(10) Pub. No.: US 2026/0329274 A1
(43) Pub. Date: Oct. 22, 2026

(54) MOWING TRAJECTORY PROCESSING METHOD, USER TERMINAL, AND INTELLIGENT MOWER

(71) Applicant: JIANGSU DONGCHENG M&E TOOLS CO., LTD., NANTONG (CN)

(72) Inventor: WEIQI HU, NANTONG (CN)

(21) Appl. No.: 19/724,909

(22) Filed: Jun. 30, 2026

Related U.S. Application Data
(63) Continuation of application No. PCT/CN2025/146636, filed on Dec. 29, 2025.

(30) Foreign Application Priority Data
Dec. 30, 2024 (CN) 202411972819.4

(51) Int. Cl. G05D 1/224; A01D 34/00; G05D 1/86; H04W 4/40; H04W 4/80; A01D 101/00; G05D 107/20; G05D 109/10; G05D 111/30

(52) U.S. Cl. CPC G05D 1/2246; A01D 34/008; G05D 1/86; H04W 4/40; H04W 4/80; A01D 2101/00; G05D 2107/23; G05D 2109/10; G05D 2111/32

(57) ABSTRACT

The present disclosure relates to the field of mowers and provides a method for processing a mowing trajectory, a user terminal, and an intelligent mower. The method includes: in response to the user terminal being communicatively connected to an intelligent mower via Bluetooth, receiving in real time a mowing trajectory for a mowing task from the intelligent mower; and retaining the mowing trajectory in response to receiving an interruption instruction or an end instruction for the mowing task from a user, and clearing the mowing trajectory in response to receiving a deletion instruction or an instruction for starting a new mowing task from the user. In the present disclosure, the user terminal can receive the mowing trajectory of the intelligent mower for the mowing task in real time, and can view the real-time mowing trajectory on the user terminal at any time.

### CROSS-REFERENCE TO RELATED APPLICATIONS

The present application is a continuation of PCT Patent Application No. PCT/CN2025/146636, entitled “MOWING TRAJECTORY PROCESSING METHOD, USER TERMINAL, AND INTELLIGENT MOWER,” filed December 29, 2025, which claims priority to Chinese patent application No. 202411972819.4, entitled “MOWING TRAJECTORY PROCESSING METHOD, USER TERMINAL, AND INTELLIGENT MOWER,” filed December 30, 2024, each of which is incorporated by reference herein in its entirety.

### TECHNICAL FIELD

The present disclosure relates to the field of mowers, and in particular to a method for processing a mowing trajectory, a user terminal, and an intelligent mower.

### BACKGROUND

An intelligent mower is an automated device adopting advanced technology, capable of automatically mowing, reducing manual labor, and improving the efficiency and accuracy of lawn management. The intelligent mower typically adopts various technologies such as artificial intelligence, sensor technology, and automatic navigation, and is capable of autonomous operation, obstacle avoidance, and intelligent adjustment of operation modes according to the growth condition of the lawn.

In related technologies, when an intelligent mower is connected to the Internet, it synchronizes the mowing trajectory corresponding to the mowing task to a cloud after mowing, and a user can acquire and view the mowing trajectory through a user terminal by interaction with the cloud.

### SUMMARY

Embodiments of the present disclosure provide a method for processing a mowing trajectory, a user terminal, and an intelligent mower.

Some embodiments of the present disclosure provide a method for processing a mowing trajectory and applicable to a user terminal. The method includes: in response to the user terminal being communicatively connected to an intelligent mower via Bluetooth, receiving in real time a mowing trajectory for a mowing task from the intelligent mower; and retaining the mowing trajectory in response to receiving an interruption instruction or an end instruction for the mowing task from a user, and clearing the mowing trajectory in response to receiving a deletion instruction or an instruction for starting a new mowing task from the user.

Some embodiments of the present disclosure provide another method for processing a mowing trajectory and applicable to an intelligent mower. The method includes: in response to the intelligent mower being communicatively connected to the user terminal via Bluetooth, sending in real time a mowing trajectory of the intelligent mower for a mowing task to a user terminal, where the user terminal is configured to perform operations of the method for processing a mowing trajectory as illustrated above.

Some embodiments of the present disclosure provide a user terminal including: at least one first processor; and a first memory being communicatively connected to the at least one first processor. The first memory is configured to store instructions, which, when executed by the at least one first processor, causes the at least one first processor to perform operations of the method for processing a mowing trajectory as illustrated above.

Some embodiments of the present disclosure provide an intelligent mower including: at least one second processor; and a second memory being communicatively connected to the at least one second processor. The second memory is configured to store instructions, which, when executed by the at least one second processor, causes the at least one second processor to perform operations of the method for processing a mowing trajectory as illustrated above.

### BRIEF DESCRIPTION OF THE DRAWINGS

Exemplary illustrations of one or more embodiments are provided by reference to pictures in the corresponding accompanying drawings. These exemplary illustrations do not constitute a limitation on the embodiments.

FIG. 1 is a flowchart of a method for processing a mowing trajectory provided in some embodiments of the present disclosure;

FIG. 2 is a schematic diagram of a structure of a user terminal provided in some embodiments of the present disclosure;

FIG. 3 is a schematic diagram of a structure of an intelligent mower provided in some embodiments of the present disclosure;

FIG. 4 is a schematic diagram showing the user terminal and the intelligent mower that are communicatively connected to each other according to some embodiments of the present disclosure; and

FIG. 5 is a schematic diagram of a mowing trajectory map displayed on a display interface of the user terminal according to some embodiments of the present disclosure.

### DETAILED DESCRIPTION OF THE EMBODIMENTS

To make the objectives, technical solutions, and advantages of the embodiments of the present disclosure clearer, embodiments of the present disclosure will be described in detail below with reference to the accompanying drawings. Those skilled in the art shall understand that, in each embodiment of the present disclosure, many technical details are proposed for the reader to better understand the present disclosure. However, even without these technical details and various changes and modifications based on the following embodiments, the technical solutions claimed in the present disclosure can also be implemented. The division of the following embodiments is for the convenience of description, and should not constitute any limitation on the specific implementation of the present disclosure, and the embodiments can be combined with each other and referred to each other on the premise of no contradiction.

In related technologies, when the intelligent mower is not connected to the Internet, it cannot synchronize the trajectory to the cloud, such that the user cannot view the mowing trajectory. Moreover, in related technologies, the mowing trajectory is usually not synchronized until the mowing task is completed. When the mowing task is interrupted, the mowing trajectory is not stored to the cloud at that time, thus the user also cannot view the mowing trajectory, resulting in poor user experience.

Embodiments of the present disclosure relate to a mowing system, including: an intelligent mower, a user terminal, and a cloud.

During operation of the intelligent mower, depending on its design and usage scenario, the intelligent mower may be in a networked state or a non-networked state. The networked state includes a Wireless Fidelity (Wi-Fi) mode and a Fourth Generation Mobile Communication Technology (4G) mode, and the non-networked state includes a Bluetooth mode.

When the networked state is the Wi-Fi mode, the intelligent mower performs mowing in a coverage area of a Wi-Fi signal. When there is no Wi-Fi in the operation area of the intelligent mower, the intelligent mower automatically switches to a 4G network, which requires the intelligent mower to have a built-in Subscriber Identity Module (SIM) card and good 4G network signal. When there is no Wi-Fi in the operation area of the intelligent mower and the 4G network signal is poor, the intelligent mower automatically switches to the Bluetooth mode. The switching of these modes is usually automatically handled by the intelligent system of the intelligent mower to ensure that the intelligent mower can successfully perform tasks in different operation environments.

When the intelligent mower is in the networked state, it can communicate with the cloud; and when the intelligent mower is in the non-networked state, it can communicate with the user terminal.

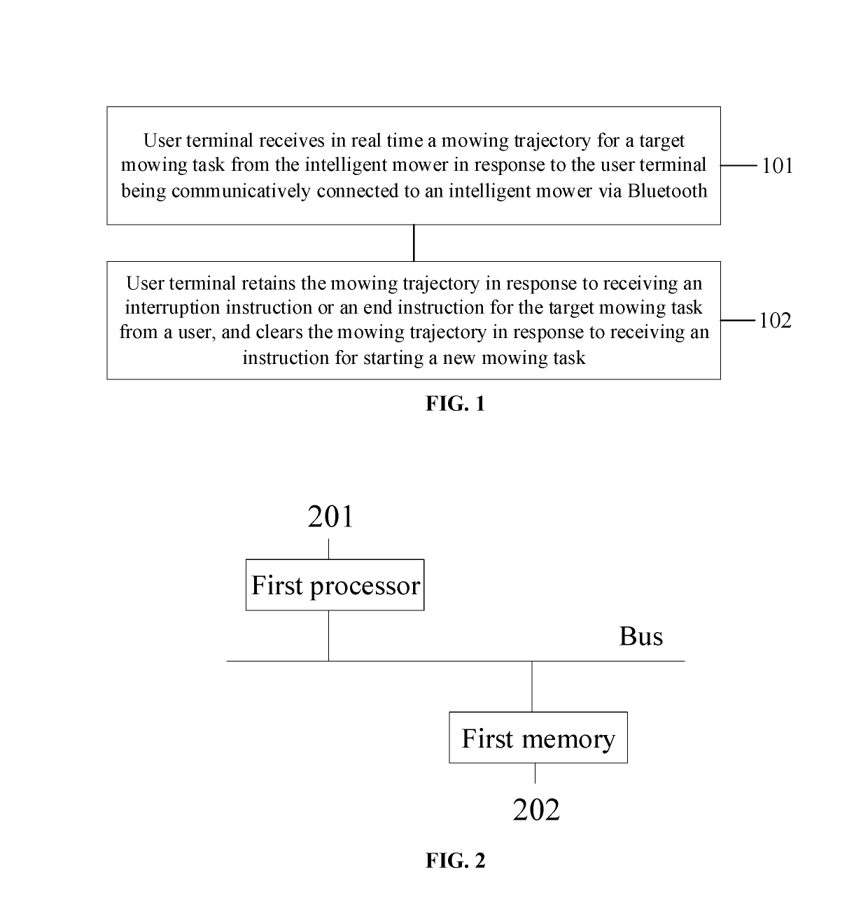

Based on the mowing system illustrated above, some embodiments of the present disclosure provide a method for processing a mowing trajectory. FIG. 1 is a flowchart of a method for processing a mowing trajectory provided in some embodiments of the present disclosure. As shown in FIG. 1 and FIG. 4, the method is applicable to the user terminal 400 in the above mowing system, and includes the following operations.

At operation 101, a mowing trajectory for a mowing task is received from an intelligent mower 500 in response to the user terminal 400 being communicatively connected to the intelligent mower 500 via Bluetooth.

When the user terminal 400 is communicatively connected to the intelligent mower 500 via Bluetooth, the user may set a mowing task including information such as a mowing area, an operation duration, and a starting position on the user terminal, and the user terminal may transmit this information to the intelligent mower via Bluetooth. The intelligent mower may generate an ideal mowing trajectory for the mowing task based on this information. The intelligent mower may receive a control command from the user terminal via Bluetooth to start the mowing task. After starting the mowing task, the intelligent mower may transmit the current mowing trajectory to the user terminal in real time via Bluetooth.

The mowing trajectory includes a mowed trajectory (movement trajectory) of the intelligent mower for the mowing task, i.e. historical positions and a current position (which are displayed as a dynamically updated path or map) of the mower on the lawn after starting of the mowing task. Of course, the mowing trajectory may further include mowing progress. The user terminal receives and displays in real time the mowing trajectory of the intelligent mower for the mowing task, which is conducive to monitoring the operation condition of the intelligent mower for the user.

In the embodiments of the present disclosure, data transmission between the intelligent mower and the user terminal may adopt a low-power Bluetooth protocol.

In addition to the mowing trajectory, the Bluetooth connection may also support other real-time feedback functions, such as: fault report (when the intelligent mower encounters an obstacle or fails, it transmits the information to the user terminal to prompt the user to take corresponding action), battery status (real-time view of the battery level and charging status of the intelligent mower), environmental perception (the intelligent mower may feed environmental data back to the user terminal to provide more intelligent operation suggestions).

At operation 102, the mowing trajectory is retained in response to receiving an interruption instruction or an end instruction for the mowing task from a user, and the mowing trajectory is cleared in response to starting a new mowing task.

The user issues an interruption instruction or an end instruction through the user terminal to notify the intelligent mower to pause the current mowing task or directly end the current mowing task. The instruction(s) is sent to the intelligent mower via Bluetooth, and the intelligent mower responds and stops the mowing action.

When the mowing task ends or is interrupted, the intelligent mower transmits the current mowing trajectory to the user terminal via Bluetooth, and the user terminal retains the mowing trajectory. In this way, before a new mowing task is started, the user can view the previous mowing trajectory at any time.

When the user starts a new mowing task, the user issues the new mowing task through the user terminal. At this time, the intelligent mower may re-plan the mowing path according to the new mowing task and start the mowing operation.

After the intelligent mower receives the new mowing task, the user terminal may clear the previous mowing trajectory and receives in real time the mowing trajectory of the intelligent mower for the new mowing task. The new mowing task includes either a mowing task with a spatial scope or a time scope which is different from that of the previous mowing task, or a mowing task under an operation condition or operation mode which is different from that of the previous mowing task.

Of course, when the intelligent mower receives a deletion instruction from the user, the user terminal also clears the previous mowing trajectory.

In the embodiments of the present disclosure, even if the task is interrupted, the Bluetooth connection remains valid, ensuring that all mowing trajectories can be synchronized to the user terminal in a timely manner. Through the Bluetooth connection, the user terminal can continuously acquire relevant information of the intelligent mower, regardless of whether the mowing task is in progress, completed, or interrupted.

In the embodiments of the present disclosure, when the intelligent mower cannot connect to a network, it communicatively connects to the user terminal via Bluetooth, so that the user terminal can receive the mowing trajectory of the intelligent mower for the mowing task in real time, and the user can view the real-time mowing trajectory on the user terminal at any time. Moreover, when the mowing task is interrupted, the user terminal retains the mowing trajectory, so that the user can still find and view the mowing trajectory, thereby improving user experience.

Based on the method for processing a mowing trajectory shown in FIG. 1, in some embodiments, retaining the mowing trajectory in the above operation 102 includes: displaying the mowing trajectory on a display interface 401 of the user terminal 400. In this case, clearing the mowing trajectory includes: clearing the mowing trajectory from the display interface 401 of the user terminal 400.

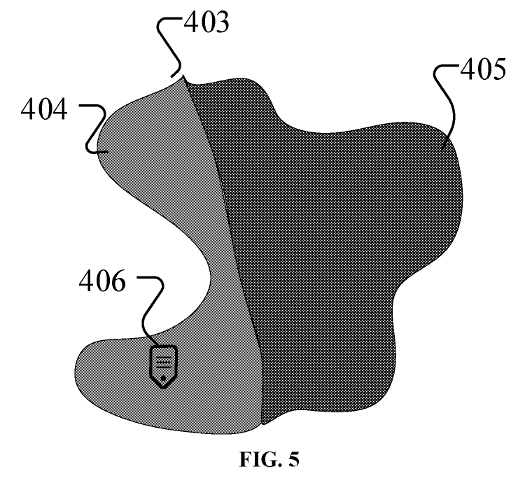

After the user terminal receives the interruption instruction or the end instruction for the mowing task from the user and before a new mowing task is started, referring to FIG. 5, the user terminal may display a static mowing trajectory map 403, indicating which areas have already been mowed (i.e. the mowed areas 404) and which areas have not yet been mowed (i.e. the unmowed areas 405). The user can view the traveling trajectory of the intelligent mower through a map view or a path tracking view. When the mowing task is interrupted or ended, the user will see a “Task Interrupted/Ended” prompt on the display interface 401 of the user terminal 400, and the display of the mowing area remains unchanged.

Of course, after the mowing task is interrupted or ended, the user terminal may continue to display the current mowing trajectory until a new mowing task starts. The displayed content may further include: the mowed areas 404 (e.g., areas filled with a color or paths marked as “completed”), the unmowed areas 405 or the remaining part of the task, and a marker 406 of the current position of the mower 500.

When the user starts a new mowing task, the intelligent mower may receive the instruction for the new mowing task, re-plan the mowing paths, and executes the new mowing task. After the new task starts, the user terminal may automatically clear the old mowing trajectory and update the mowing trajectory to the real-time mowing trajectory of the intelligent mower for the new mowing task.

In some embodiments, the user terminal may provide a button 402 or an option to allow the user to manually clear the historical mowing trajectory. When a new mowing task starts, the user may clear the old trajectory data, and the interface will display information about the new task. To prevent misoperation, when the user starts a new mowing task, the user terminal may provide a prompt for confirmation of clearing, for example: “A new mowing task is about to start, do you want to clear the mowing trajectory of the current task?” This ensures that the user understands the clearing operation.

In order to ensure user experience, a smooth transition process may be provided between the interruption of the mowing task and the start of a new mowing task. For example, when the new mowing task starts, a transition animation is displayed or a prompt is shown to the user that the new mowing task is restarting, and then the interface is refreshed to display the trajectory of the new task. On the user terminal, the switching of task states should be seamless. When the user ends the current task, the system can quickly update the display, ensuring a natural and smooth task transition without affecting the user's operating experience.

In the embodiments of the present disclosure, when the user interrupts or ends the mowing task, the user terminal may retain the current mowing trajectory by continuously updating the display interface of the user terminal until a new mowing task starts. Through a clear interface design and data synchronization mechanism, it is ensured that the user can conveniently view and manage tasks.

Based on the method for processing a mowing trajectory shown in FIG. 1, in some embodiments, retaining the mowing trajectory in the above operation 102 includes: storing the mowing trajectory; receiving a first query instruction for the mowing trajectory from the user; and performing query, and displaying the mowing trajectory on a display interface of the user terminal. In this case, clearing the mowing trajectory in the above operation 102 includes: deleting the mowing trajectory, and clearing the mowing trajectory from the display interface of the user terminal.

Upon the user terminal receives the interruption instruction or the end instruction for the mowing task from the user, it saves the mowing trajectory of the mowing task to a local storage as a historical record of the task.

The user may initiate a query operation on the user terminal to view the stored mowing trajectory. In some embodiments, the user terminal initiates a query request to the local storage, and queries and returns the mowing trajectory saved when the task was interrupted or ended. The display interface of the user terminal may be updated to present the mowing trajectory, ensuring that the user can clearly see the mowed and unmowed areas. The user may use a finger or a touch device to scroll to view the areas, or zoom in/out to view specific path details.

When the user starts a new mowing task, the intelligent mower may receive the instruction for the new mowing task. This may trigger the following operations: the user terminal sends a request to confirm whether to clear the current mowing trajectory, or directly clears all displayed content. When the historical mowing trajectory is no longer needed when the new mowing task is started, the user terminal clears the historical data from the local display and the historical record. For example, the user terminal may delete the saved historical mowing trajectory (or marks it as expired data) and clear the mowing trajectory from the display interface of the user terminal. To ensure that the user understands the start of the new mowing task and the clearing operation, the user terminal may provide a prompt message: “A new task has been started, and the historical mowing trajectory has been cleared.” A button for confirmation of clearing may also be provided on the user interface to ensure that the operation is authorized by the user.

In the embodiments of the present disclosure, the mowing trajectory and task data may be saved in the local storage until the user queries or a new mowing task is started. The current mowing trajectory may be automatically saved at each interruption or ending of the task. When the user queries the mowing trajectory on the user terminal, the user terminal may synchronize the data from the background storage and presents the result to the user.

In the embodiments of the present disclosure, the user may query and view the mowing trajectory on the display interface of the terminal after interrupting or ending the mowing task, until a new task starts. When a new task starts, the system may automatically clear the displayed historical mowing trajectory and updates it to the progress of the new task. This mechanism not only provides flexible task management functions but also ensures that the user can conveniently view the mowing progress and quickly start a new task when needed.

Based on the mowing system illustrated above, some embodiments of the present disclosure provide a method for processing a mowing trajectory applicable to the intelligent mower in the above mowing system. The method includes: sending in real time a mowing trajectory of the intelligent mower for a mowing task to the user terminal in response to the intelligent mower being communicatively connected to the user terminal via Bluetooth.

The intelligent mower is typically equipped with a series of sensors to track the movement and position of the intelligent mower. Through these sensors, the intelligent mower can accurately record its mowing trajectory during the mowing task, including data such as the current position, traveling direction, and mowed areas.

The mower and the user terminal are communicatively connected to each other via a low-power Bluetooth connection. The low-power Bluetooth connection is suitable for real-time data transmission and has high energy efficiency, making it suitable for the continuous and low-bandwidth data transmission between the intelligent mower and the user terminal.

In the embodiments of the present disclosure, when the intelligent mower cannot connect to a network, it connects to the user terminal via Bluetooth, so that the user terminal can receive the mowing trajectory of the intelligent mower for the mowing task in real time, and the user can view the real-time mowing trajectory on the user terminal at any time, thereby improving user experience.

Based on the method for processing a mowing trajectory illustrated above, in some embodiments, the method further includes: receiving an interruption request or an end request for the mowing task sent by the user terminal; stopping mowing; retaining the mowing trajectory; and clearing the mowing trajectory in response to the intelligent mower reaching a preset condition.

The user terminal communicates with the intelligent mower via a Bluetooth connection. When the user pauses or ends the mowing task, the user terminal sends an interruption request or an end request to the intelligent mower. The interruption request or the end request may be a specific instruction or command. For example, the interruption request or the end request may include a request type (indicating whether the mowing task is to be stopped, paused, or ended), a time stamp (recording the time when the interruption request or the end request occurs to help the intelligent mower synchronize), and a status of the current mowing area (information for indicating whether the current mowing area is completed, so that when the task is resumed, the intelligent mower can determine whether to continue the uncompleted area based on the status).

After receiving the interruption request or the end request, the intelligent mower may immediately stop all mowing activities. This can be achieved by interrupting the motor, stopping navigation control, or the like. The state of the intelligent mower may be switched from “operating” to “paused” or “stopped.”

When stopping mowing, the intelligent mower retains the current mowing trajectory. When the user sends a request for a new mowing task through the user terminal, the intelligent mower receives the instruction and executes the new task. In this case, the intelligent mower may clear the previous mowing trajectory and prepares to start the new mowing task.

The intelligent mower may confirm to the user terminal via Bluetooth that the new mowing task has been successfully started, and the interface of the user terminal may be updated to a “mowing in progress” state, and display the mowing areas and progress of the new mowing task.

On the user terminal, the interface may include arresting operation buttons (e.g., “pause”, “stop”, or “start new task”). When the mowing task is interrupted, the interface displays “Task Paused” or “Task Stopped”, and indicates the currently completed mowing area. The user can understand the interruption status of the task by viewing a map or a progress bar. When the user starts a new mowing task, the interface may switch to a map of the new mowing area and displays the progress of ongoing mowing.

In the embodiments of the present disclosure, when the mowing task is interrupted or ended, the intelligent mower retains the mowing trajectory, so that the user can find and view the mowing trajectory on the user terminal, thereby improving user experience.

Based on the method for processing a mowing trajectory illustrated above, in some embodiments, retaining the mowing trajectory by the intelligent mower includes: displaying the mowing trajectory on a display interface of the intelligent mower. In this case, clearing the mowing trajectory includes: clearing the mowing trajectory from the display interface of the intelligent mower.

The intelligent mower may display the currently completed mowing trajectory on the display interface of the intelligent mower in the form of paths, which are typically shown as polyline-style or map-style paths, in order to present the movement trajectory of the intelligent mower.

When receiving the interruption request or the end request for the mowing task sent by the user terminal, the intelligent mower enters a standby state, waiting for the user to send a new task request through the user terminal. In this case, the display interface of the intelligent mower may continue to display the completed mowing trajectory of the mowing task.

When the user terminal sends an instruction for a new mowing task, the intelligent mower restarts the task. At the starting of the new mowing task, the intelligent mower may clear the historical trajectory data of the mowing task from the display interface and updates the display interface to the state of the new mowing task. The display interface may show the path planning and task progress of the new mowing task.

In the embodiments of the present disclosure, the user may view the mowing trajectory of the mowing task before the new mowing task starts, and the display interface may not clear the previous trajectory and be updated to the progress of the new task until the new mowing task starts. This design not only improves user experience but also enhances the intelligence and flexibility of the intelligent mower.

Based on the method for processing a mowing trajectory illustrated above, in some embodiments, retaining the mowing trajectory by the intelligent mower includes: storing the mowing trajectory; receiving a second query instruction for the mowing trajectory from the user; and performing query, and displaying the mowing trajectory on a display interface of the intelligent mower. In this case, clearing the mowing trajectory includes: deleting the mowing trajectory, and clearing the mowing trajectory from the display interface of the intelligent mower.

When executing the mowing task, the intelligent mower may record in real time information such as the current position, mowing trajectory, and mowing areas into an internal memory. The data may be stored according to time stamps or distributed into multiple small blocks for management and query.

After the mowing task is interrupted or ended, the user may initiate a second query operation through the user terminal to view the mowing trajectory, or the user may directly perform a second query operation on the intelligent mower to view the mowing trajectory.

When receiving the second query request, the intelligent mower may extract the recorded trajectory data from the storage, formats the data, and prepares it for display. When displaying the mowing trajectory, time stamp and status information may be shown to help the user understand the progress and completion degree of the mowing task.

The intelligent mower may receive a request to start a new mowing task sent by the user terminal, or start a new mowing task in response to an operation directly on the intelligent mower by the user. After receiving the new mowing task, the intelligent mower may immediately stop displaying the existing mowing trajectory. Moreover, when the new mowing task starts, the intelligent mower may clear the historical trajectory data (or retain part of the historical records, but no longer display them on the current display interface).

The display interface of the intelligent mower changes to a “new task started” state, which may be a map view or the initial planning state of the task. The paths of the new mowing task are displayed, and the display interface is updated to the target areas and paths of the current task.

In the embodiments of the present disclosure, the intelligent mower may store the mowing trajectory after interruption of the task and support the user in querying and viewing these trajectories. When a new task starts, the intelligent mower may clear the displayed historical trajectory and prepare to display the paths and targets of the new task. This design provides a flexible user interaction and optimizes user experience.

Based on the method for processing a mowing trajectory illustrated above, in some embodiments, the method further includes: uploading in real time the mowing trajectory of the intelligent mower for the mowing task to a cloud in response to the intelligent mower disconnecting a Bluetooth connection with the user terminal and establishing a network connection with the cloud, to allow the user terminal to acquire the mowing trajectory from the cloud.

After the user terminal is connected to the intelligent mower via Bluetooth, when the user instructs to disconnect, the intelligent mower disconnects the Bluetooth connection with the user terminal. The intelligent mower detects Wi-Fi or 4G signals in real time. When the signal is good, the intelligent mower automatically disconnects the Bluetooth connection with the user terminal and establishes connection through Wi-Fi or 4G.

After successfully establishing a network connection (through Wi-Fi or 4G), the intelligent mower may perform data uploading and establish a continuous connection with the cloud to maintain data synchronization. During the mowing task, the intelligent mower may periodically upload the mowing trajectory to the cloud. The upload interval may be set to a certain time period or a certain travelling distance of the intelligent mower.

The cloud may provide a database for the intelligent mower to store the uploaded mowing trajectories. Each mowing trajectory in the database may include fields such as time stamp, position coordinates, and mower status. A respective unique identifier may be assigned to each user or user terminal to distinguish mowing trajectory data. The cloud may provide an Application Programming Interface (API) for the user terminal to query mowing trajectories.

The API may return historical trajectory data of the intelligent mower, including information such as start time, end time, completed areas, and paths. The cloud may also process the mowing trajectory as needed, such as calculating the efficiency of the intelligent mower, estimating an area of unmowed areas, or the like. The cloud may track the status of the mower in real time (e.g., “mowing”, “paused”, or “completed”) and update the display interface on the user terminal. By updating the task status in real time, the user can view the task progress at any time. When the intelligent mower fails or stops during mowing, the cloud may receive the status update in real time and notify the user through a notification mechanism.

The user terminal communicates with the cloud via the API to acquire historical trajectory data of the intelligent mower. The user may view the mowing trajectory in a specified time period or for a specified task, and may query data using parameters such as time and task identifier. The cloud returns the query result, typically including information of the trajectory such as coordinate lists, time stamps, and mowing status. The user terminal may parse the trajectory data acquired from the cloud and displays it to the user in a graphical manner. For example, the user terminal may display the moving paths of the intelligent mower, and present the trajectory using a map view or a polyline chart. The mowing area may be displayed using different colors or filling graphics to indicate the mowed areas 404 and the unmowed areas 405, thus the task completion status can be easily understandable. The user terminal may also acquire the real-time position and status of the intelligent mower through a real-time data stream, so that the user can check the working progress of the intelligent mower in real time. When the mowing task is in progress, the user can see the real-time updated mowing trajectory on the display interface of the user terminal.

In the embodiments of the present disclosure, by connecting the intelligent mower to the cloud and uploading mowing trajectory data in real time, the user can query and view the operation trajectory of the intelligent mower on the terminal device in real time. After establishing connection to a network, the intelligent mower uploads real-time data to the cloud and synchronizes data with the user terminal through the API interface, achieving management and visualization of data during the mowing process.

The division of operations of the methods above is only for the convenience of illustration. When implementing, they may be combined into one operation, or some operations may be split. As long as they include the same logical relationship, they are within the scope of protection of the present disclosure. Adding insignificant modifications or introducing insignificant designs to the algorithm or process without changing the core design of the algorithm and process is also within the scope of protection of the present disclosure.

Some embodiments of the present disclosure provide a user terminal. FIG. 2 is a schematic diagram of a structure of the user terminal provided in some embodiments of the present disclosure. As shown in FIG. 2, the user terminal includes: at least one first processor 201; and a first memory 202 being communicatively connected to the at least one first processor 201. The first memory 202 is configured to store instructions, which, when executed by the at least one first processor 201, causes the at least one first processor 201 to perform operations of the method for processing a mowing trajectory as illustrated above.

The first memory 202 and the at least one first processor 201 are connected to each using buses, and the buses may include any number of interconnected buses and bridges. The buses are configured to connect together various circuits such as the at least one first processors and the first memory.

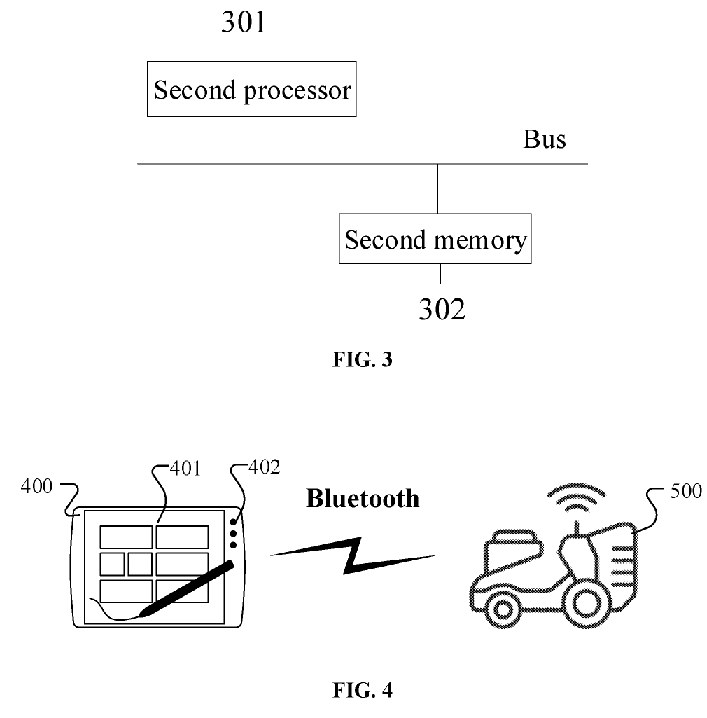

Some embodiments of the present disclosure provide an intelligent mower. FIG. 3 is a schematic diagram of a structure of the intelligent mower provided in some embodiments of the present disclosure. As shown in FIG. 3, the intelligent mower includes: at least one second processor 301; and a second memory 302 being communicatively connected to the at least one second processor 301. The second memory 302 is configured to store instructions, which, when executed by the at least one second processor 301, causes the at least one second processor 301 to perform operations of the method for processing a mowing trajectory as illustrated above.

The second memory 302 and the at least one second processor 301 are connected to each using buses, and the buses may include any number of interconnected buses and bridges. The buses are configured to connect together various circuits such as the at least one second processors and second first memory.

Some embodiments of the present disclosure provide a non-transitory computer-readable storage medium configured to store a computer program, which, when executed by a processor, causes the processor to perform operations of the method for processing a mowing trajectory as illustrated above.

Those skilled in the art shall understand that all or part of the operations of the methods as illustrated above may be implemented by a program instructing relevant hardware, and the program is stored in a storage medium and includes a number of instructions to cause a device (which may be a microcontroller, a chip, etc.) or a processor to execute all or part of the operations of the methods as illustrated in the embodiments of the present disclosure. The aforementioned storage medium includes: a USB flash drive, a mobile hard disk, a read-only memory (ROM), a random access memory (RAM), a magnetic disk, an optical disk, or other media that can store program code.

Those skilled in the art shall understand that the above-mentioned embodiments are specific examples for implementing the present disclosure. In practice, various changes may be made in form and details without departing from the scope of the present disclosure.

What is claimed is:

1. A method for processing a mowing trajectory, applicable to a user terminal, wherein the method comprises:
in response to the user terminal being communicatively connected to an intelligent mower via Bluetooth, receiving a mowing trajectory for a mowing task from the intelligent mower; and
retaining the mowing trajectory in response to receiving an interruption instruction or an end instruction for the mowing task from a user, and clearing the mowing trajectory in response to receiving a deletion instruction or an instruction for starting a new mowing task from the user.

2. The method according to claim 1, wherein retaining the mowing trajectory comprises:
displaying the mowing trajectory on a display interface of the user terminal; and
clearing the mowing trajectory comprises:
clearing the mowing trajectory from the display interface of the user terminal.

3. The method according to claim 1, retaining the mowing trajectory comprises:
storing the mowing trajectory;
receiving a first query instruction for the mowing trajectory from the user; and
performing query, and displaying the mowing trajectory on a display interface of the user terminal; and
clearing the mowing trajectory comprises:
deleting the mowing trajectory, and clearing the mowing trajectory from the display interface of the user terminal.

4. The method according to claim 1, wherein the mowing task comprises a mowing area, an operation duration, and a starting position.

5. The method according to claim 1, wherein the mowing trajectory comprises a mowed trajectory of the intelligent mower for the mowing task, and the mowed trajectory comprises historical positions and a current position of the intelligent mower after starting of the mowing task.

6. The method according to claim 5, wherein the historical positions comprise dynamically updated paths or maps.

7. The method according to claim 1, further comprising:
receiving a fault report and a battery status of the intelligent mower in response to the user terminal being communicatively connected to the intelligent mower via Bluetooth.

8. The method according to claim 1, wherein after receiving the interruption instruction or the end instruction for the mowing task from the user, the method further comprises:
displaying, on the user terminal, a static mowing trajectory map, wherein the mowing trajectory map comprises a mowed area and an unmowed area.

9. The method according to claim 8, wherein the mowed area and the unmowed area are colored respectively, and a color for the mowed area is different from a color for the unmowed area.

10. The method according to claim 8, wherein the mowing trajectory map further comprises a marker of a current position of the intelligent mower.

11. The method according to claim 1, wherein the user terminal comprises a button or an option for the user to manually trigger clearing of the mowing trajectory.

12. A method for processing a mowing trajectory, applicable to an intelligent mower, wherein the method comprises:
in response to the intelligent mower being communicatively connected to the user terminal via Bluetooth, sending in real time a mowing trajectory of the intelligent mower for a mowing task to a user terminal, wherein the user terminal is configured to perform operations of the method for processing a mowing trajectory according to claim 1.

13. The method according to claim 12, further comprising:
receiving an interruption request or an end request for the mowing task sent by the user terminal;
stopping mowing;
retaining the mowing trajectory; and
clearing the mowing trajectory in response to receiving a deletion instruction or an instruction for starting a new mowing task from the user.

14. The method according to claim 13, wherein retaining the mowing trajectory comprises:
displaying the mowing trajectory on a display interface of the intelligent mower; and
clearing the mowing trajectory comprises:
clearing the mowing trajectory from the display interface of the intelligent mower.

15. The method according to claim 13, wherein retaining the mowing trajectory comprises:
storing the mowing trajectory;
receiving a second query instruction for the mowing trajectory from the user; and
performing query, and displaying the mowing trajectory on a display interface of the intelligent mower.

16. The method according to claim 15, wherein clearing the mowing trajectory comprises:
deleting the mowing trajectory, and clearing the mowing trajectory from the display interface of the intelligent mower.

17. The method according to claim 13, wherein the interruption request or the end request comprises a time stamp configured for recording a time when the interruption request or the end request occurs.

18. The method according to claim 13, wherein the interruption request or the end request comprises a status of a current mowing area configured for recording whether mowing of the current mowing area is completed.

19. The method according to claim 12, further comprising:
uploading in real time the mowing trajectory of the intelligent mower for the mowing task to a cloud in response to the intelligent mower disconnecting a Bluetooth connection with the user terminal and establishing a network connection with the cloud, to allow the user terminal to acquire the mowing trajectory from the cloud.

20. A user terminal comprising:
at least one first processor; and
a first memory being communicatively connected to the at least one first processor;
wherein the first memory is configured to store instructions, which, when executed by the at least one first processor, causes the at least one first processor to perform operations of the method for processing a mowing trajectory according to claim 1.
